(19) United States
(12) Patent Application Publication
(10) Pub. No.: US 2010/0128913 A1
(43) Pub. Date: May 27, 2010

(54) PORTABLE DEVICE ACCESSORY AND METHODS OF MANUFACTURE

(75) Inventors: Oliver Duncan Seil, Pasadena, CA (US); Vincent Razo, Granada Hills, CA (US); Chad Dejong, Los Angeles, CA (US); David Kleeman, Marina del Rey, CA (US); Pauline Chang, Los Angeles, CA (US); Kelly Ferdman, Los Angeles, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 12/466,383

(22) Filed: May 14, 2009

Related U.S. Application Data
(60) Provisional application No. 61/127,660, filed on May 14, 2008.
(60) Provisional application No. 61/101,658, filed on Sep. 30, 2008.

(51) Int. Cl. H04R 1/02

(52) U.S. Cl. 381/334

(57) ABSTRACT

Embodiments of portable device accessories and related methods are described herein. Other embodiments and related methods are also disclosed herein.

### CROSS REFERENCE TO RELATED APPLICATION

This application claims priority to U.S. Provisional Patent Application 61/127,660, filed on May 14, 2008, and U.S. Provisional Patent Application 61/101,658, filed on Sep. 30, 2008, the contents of both of which are incorporated herein by reference.

### FIELD OF THE INVENTION

This invention relates generally to speaker systems, and relates, more particularly, to portable speaker apparatuses and related methods.

### BACKGROUND

The portable audio market has changed dramatically in the past several years. Recent trends have focused on the improvement of overall sound quality of portable devices. Much of the improvement has occurred in the sources for sound generation. For example, portable CD audio players and MP3 audio players have garnered increasing shares of the portable market in comparison to more conventional cassette players and radio sources. While focus on such sources has helped the overall perceived sound quality, further improvements have been somewhat limited by portability constraints.

Portable audio products find wide usage in society. These audio products are often employed for work and personal use, e.g., at the office or home, as well as during travel in the car, in a park, garage, or hotel room, or even in business presentations using a laptop computer. The required portability of these audio devices limits the overall size and weight of the system and hence the types and sizes of the speaker drivers and enclosures used. Some conventional portable audio products include self-contained units such as portable radios and boomboxes to address the portability needs whereas others employ headphones, built-in laptop computer speakers, and miniature amplified speakers to accommodate portability in sound producing means.

Generally, it can be desirable from a practical use standpoint to not have to use headphones or ear buds thereby allowing the listening of content playing on the portable device and still hearing ambient sounds. Unfortunately, self-contained conventional portable audio products, such as the aforementioned portable radio and boomboxes, do not provide flexibility of use, tend to consume large amount of space proportional to their quality of output signal and typically have limited or no positional flexibility or adjustability. In other words, if a user desires to take her music with her and not limit her ambient hearing, she is likely limited to carrying a portable radio or boombox. Consequently, there is a trade-off between portability and usability.

Therefore, a need exists in the art to develop portable and usable apparatuses and related methods that address such limitations of the current technology.

### BRIEF DESCRIPTION OF THE DRAWINGS

The invention will be better understood from a reading of the following detailed description of examples of embodiments, taken in conjunction with the accompanying figures in the drawings in which:

FIG. 1 illustrates an exemplary system for providing user controlled audio entertainment from a portable device accessory coupled to a mobile media device, in accordance with the subject matter described herein.

FIG. 2 illustrates an exemplary operational system for providing user controlled audio entertainment from a portable device accessory coupled to a mobile media device, in accordance with the subject matter described herein.

FIG. 3 is an isometric close-up view illustrating speaker housing portions of a dual speaker arrangement, including portions of the flexible member mechanically coupled to the speakers, of the exemplary operational system of FIG. 2, in accordance with the subject matter described herein.

FIG. 4 illustrates multiple figure front and side views, including additional detail of a dual speaker arrangement, of the exemplary operational system of FIG. 2, in accordance with the subject matter described herein.

FIG. 5 illustrates an amplifier device housing portion, including input/output audio cables and power cable, of the exemplary operational system of FIG. 2, in accordance with the subject matter described herein.

FIG. 6 illustrates multiple figure front and side views, including additional detail of an amplifier device housing portion, of the exemplary operational system of FIG. 5, in accordance with the subject matter described herein.

FIG. 7 illustrates a front view, including additional detail, of an amplifier device housing portion of the exemplary operational system of FIG. 5, in accordance with the subject matter described herein.

FIG. 8 is a block diagram that illustrates functional portions of an amplifier device portion of the exemplary operational system of FIG. 5, in accordance with the subject matter described herein.

FIG. 9 illustrates an exemplary system for providing user controlled audio entertainment from a portable device accessory including multiple speakers and a battery powered amplifier coupled to a mobile device, in accordance with the subject matter described herein.

FIG. 10 illustrates an exemplary system for providing user controlled audio entertainment from a portable device accessory including multiple speakers and powered by a mobile media device, in accordance with the subject matter described herein.

FIG. 11 illustrates an exemplary system for providing user controlled audio entertainment from a portable device accessory including multiple speakers and an internal AC powered amplifier coupled to a mobile device, in accordance with the subject matter described herein.

FIG. 12 illustrates an exemplary system for providing user controlled audio entertainment from a portable device accessory including multiple speakers and a battery powered amplifier co-located with one of the speakers and coupled to a mobile device, in accordance with the subject matter described herein.

FIG. 13 illustrates an exemplary system for providing user controlled audio entertainment from a portable device accessory including multiple speakers and a battery powered amplifier co-located with one of the speakers and in wireless communication with a mobile media device, in accordance with the subject matter described herein.

FIG. 14 illustrates an exemplary system for providing user controlled audio entertainment from a portable device accessory including multiple speakers and an external AC powered amplifier coupled to a mobile device, in accordance with the subject matter described herein.

FIG. 15 illustrates another embodiment of the portable device accessory of FIG. 9 including multiple speakers and a battery powered amplifier coupled to a mobile device, in accordance with the subject matter described herein.

FIG. 16 illustrates another embodiment of the portable device accessory of FIG. 10 including multiple speakers and powered by a mobile media device, in accordance with the subject matter described herein.

FIG. 17 illustrates another embodiment of the portable device accessory of FIG. 11 including multiple speakers and an internal AC powered amplifier coupled to a mobile device, in accordance with the subject matter described herein.

FIG. 18 illustrates another embodiment of the portable device accessory of FIG. 12 including multiple speakers and a battery powered amplifier co-located with one of the speakers and coupled to a mobile device, in accordance with the subject matter described herein.

FIG. 19 illustrates another embodiment of the portable device accessory of FIG. 14 including a plurality of flexible members in addition to multiple speakers and an external AC powered amplifier coupled to a mobile device.

FIG. 20 illustrates another embodiment of the portable device accessory of FIG. 15 including a plurality of flexible members in addition to multiple speakers and a battery powered amplifier coupled to a mobile device, in accordance with the subject matter described herein.

FIG. 21 illustrates another embodiment of the portable device accessory of FIG. 16 including a plurality of flexible members in addition to multiple speakers and powered by a mobile media device, in accordance with the subject matter described herein.

FIG. 22 illustrates another embodiment of the portable device accessory of FIG. 17 including a plurality of flexible members in addition to multiple speakers and an internal AC powered amplifier coupled to a mobile device, in accordance with the subject matter described herein.

FIG. 23 illustrates another embodiment of the portable device accessory of FIG. 18 including a plurality of flexible members in addition to multiple speakers and a battery powered amplifier co-located with one of the speakers and coupled to a mobile device, in accordance with the subject matter described herein

FIG. 24 illustrates an exemplary system for providing user controlled audio entertainment from a portable device accessory including a single speaker and an external AC powered amplifier coupled to a mobile device, in accordance with the subject matter described herein.

FIG. 25 illustrates an exemplary system for providing user controlled audio entertainment from a portable device accessory including a single speaker and a battery powered amplifier coupled to a mobile device, in accordance with the subject matter described herein.

FIG. 26 illustrates an exemplary system for providing user controlled audio entertainment from a portable device accessory including a single speaker and powered by a mobile media device, in accordance with the subject matter described herein.

FIG. 27 illustrates an exemplary system for providing user controlled audio entertainment from a portable device accessory including a single speaker and an internal AC powered amplifier coupled to a mobile device, in accordance with the subject matter described herein.

FIG. 28 illustrates an exemplary system for providing user controlled audio entertainment from a portable device accessory including a single speaker and a battery powered amplifier co-located with the speaker and coupled to a mobile device, in accordance with the subject matter described herein.

FIG. 29 illustrates an exemplary system for providing user controlled audio entertainment from a portable device accessory including a single speaker and a battery powered amplifier co-located with the speaker and in wireless communication with a mobile media device, in accordance with the subject matter described herein.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

In one embodiment, a portable speaker assembly is provided. The portable speaker device can include: (a) a first flexible member having a first end and a second end, the first flexible member including a first flexible member cavity running from the first end of the first flexible member to the second end of the first flexible member; (b) a first speaker housing coupled to the first end of the first flexible member, the first speaker housing including a first speaker element; and (c) a first speaker input cable, the first speaker input cable having a first end and a second end, the first end of the first speaker input cable coupled to the first speaker element of the first speaker housing, the first speaker input cable of sufficient length to allow the speaker cable to couple with a mobile entertainment device.

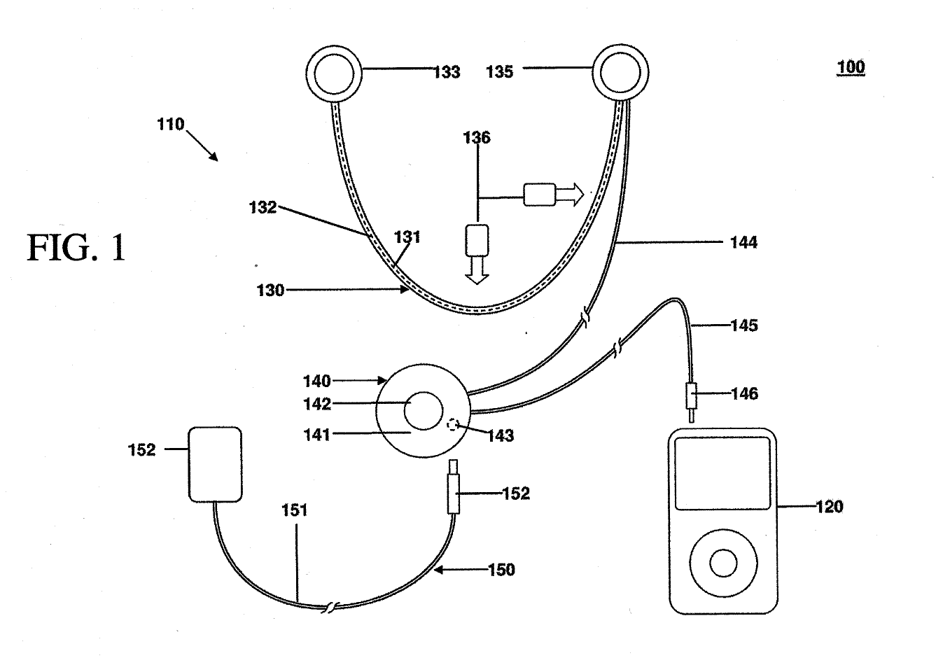

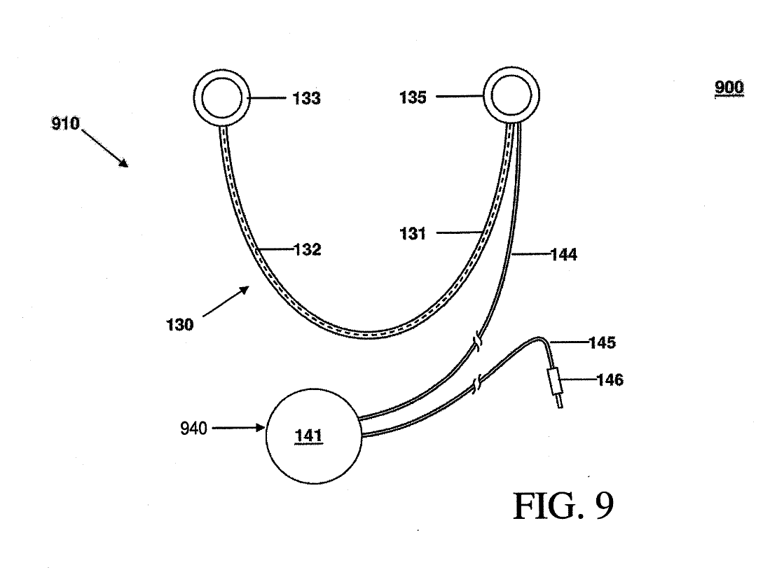

Turning to the drawings, FIG. 1 illustrates a mobile audio entertainment system 100 for providing user controlled audio entertainment from a portable device accessory that is coupled to a mobile media device. FIG. 1 includes portable device accessory 110 and mobile entertainment device 120. Portable device accessory 110 includes speaker assembly 130, amplifier assembly 140 and power assembly 150. Portable device accessory 110 is configured to receive an audio signal from mobile entertainment device 120 and provide an acoustic signal to a user and her environment. In some embodiments, portable device accessory 110 is implemented without amplifier assembly 140 and power assembly 150. In such an embodiment, mobile entertainment device 120 can provide power to operate the speakers within speaker assembly 130. In other embodiments, portable device accessory 110 is implemented without power assembly 150, and amplifier assembly 140 includes a power source, such as, for example a battery power source within amplifier assembly 140, an AC-DC power source within amplifier assembly 140, and the like. Examples of such embodiments are described in FIGS. 9-29, below.

Speaker assembly 130 is a flexible speaker assembly configured to receive an amplified audio signal, produce an acoustic signal based on the received amplified audio signal and propagate the acoustic signal into the surrounding environment. Speaker assembly 130 includes flexible member 131, speaker cable 132, left speaker 133, right speaker 135 and cable management devices 136. In some embodiments, cable management devices 136 is configured as any suitable cable management device, such as, for example a plastic clip allowing a user to secure an associated cable/cord to flexible member 131.

Flexible member 131 is a support member configured to support or position one or more objects, for example, by bending at multiple locations and at various angles along its length. Flexible member 131 includes a first end mechanically coupled to left speaker 133 and a second end mechanically coupled to right speaker 135. In some embodiments, flexible member 131 is implemented as a flexible hose with a hollow core and further includes speaker cable 132 located within the hollow core and electrically coupled to left speaker 133 and right speaker 135 and providing electrical communication between the speakers.

Flexible member 131 can be manufactured from any suitable materials, such as, for example, flexible metal tubing. Examples of flexible metal tubing include flexible gooseneck steel tubing and steel flex rod, semi-rigid polymer tubing, and the like. In some embodiments, flexible member 131 can be manufactured from flexible gooseneck steel tubing and steel flex rod available from VIMCO, Incorporated of Java City, N.Y. In other embodiments, the flexible member 131 can be implemented as a 6 millimeter (mm) diameter articulated member or gooseneck, for example, made of spring steel and steel wire, as available from Sheenway Technology Ltd. Located at Rm 1313, 13/F., Austin Tower, 22-26 Austin Ave, Tsimshatsui, Kowloon. HK, but could be manufactured from other materials, such as, a bendable aluminum rod, interlocking plastic segments, or even wire or string.

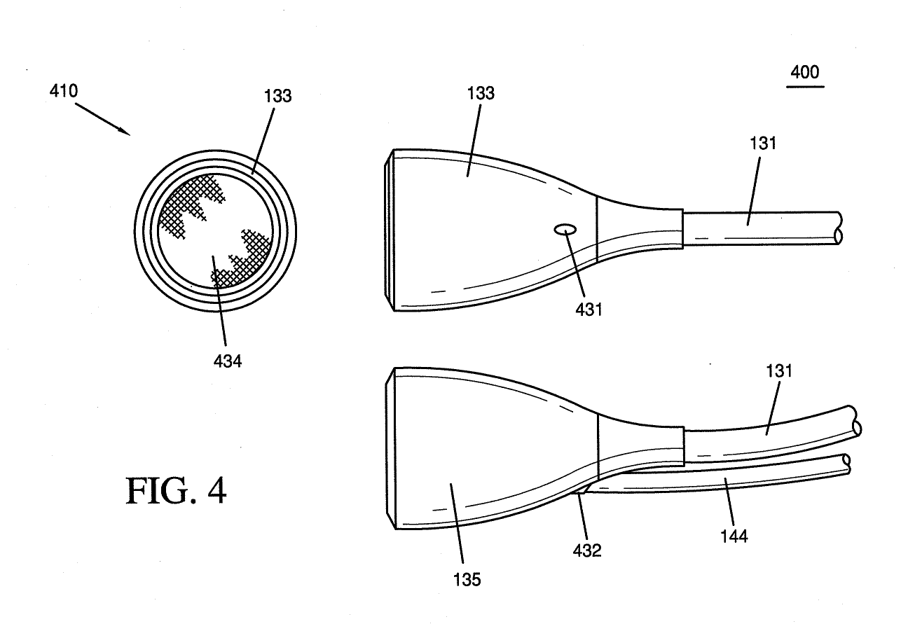

Left speaker 133 and right speaker 135 are transducer assemblies configured to receive an amplified audio signal and produce an associated acoustic signal based on the received amplified audio signal. In some embodiments, left speaker 133 and right speaker 135 are transducer assemblies manufactured as electrical devices and include magnetostrictive material and winding, which receive and transform the amplified audio signals, in the form of electrical energy, into acoustic signals. Left speaker 133 and right speaker 135 are further detailed in FIGS. 3 and 4, below.

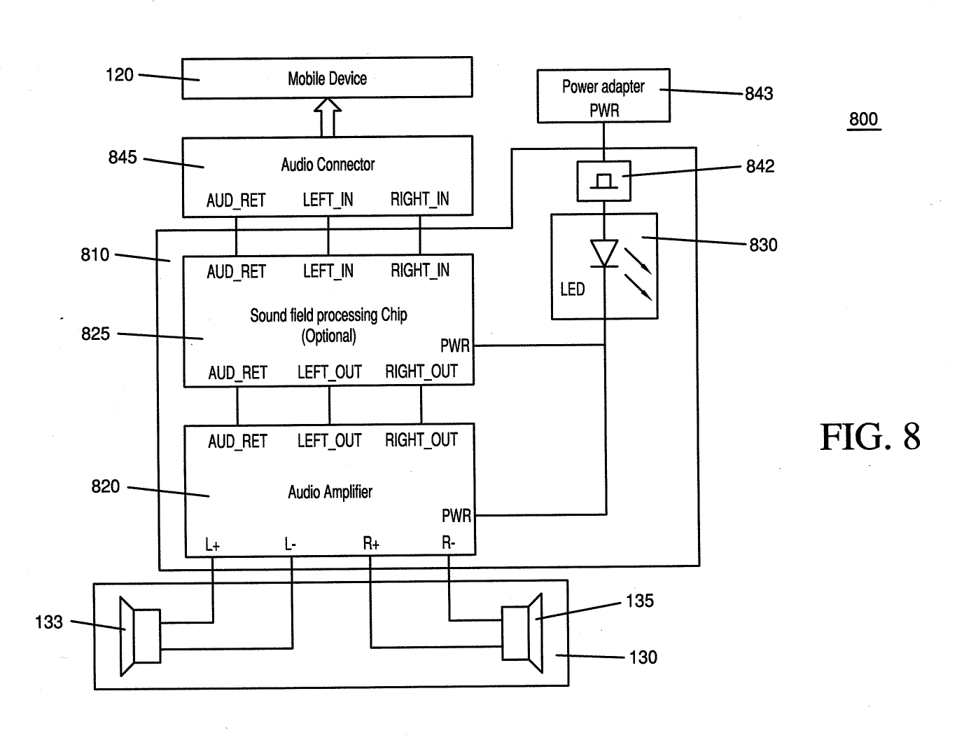

Amplifier assembly 140 is an amplification device including an amplification circuit located within a housing. The amplification circuit can be configured to receive an audio signal from a source and produce an amplified audio signal, powerful enough to drive one or more speakers, based on the received audio signal. Amplifier assembly 140 includes amplifier housing 141, amplifier switch 142, female power jack 143, speaker input cable 144 and source cable 145 including source connector 146 mechanically coupled to source cable 145. Amplifier housing 141 is configured to contain an amplifier circuit (detailed in FIG. 8, below) as well as amplifier switch 142, female power jack 143, a source cord/cable connector (not shown) and a speaker cord/cable connector (also not shown). In some embodiments, amplifier assembly 140 is co-located as part of speaker assembly 130. In such embodiments, amplifier assembly 140 may include some, none or all of the aforementioned elements.

Amplifier switch 142 is configured to allow a user to turn amplifier assembly “on” or “off” thereby resulting in mobile audio entertainment system 100 and its component elements turning “on” or “off” as well. Female power jack 143 is configured to mechanically couple with a male jack portion of a power cord/cable and provides a conduit for a DC power signal.

Speaker input cable 144 is a signal conduit that is configured to mechanically couple with the amplifier circuit portion of amplifier assembly 140 and right speaker 135 of speaker assembly 130. Speaker input cable 144 is further configured to provide a conduit for an amplified audio signal to travel from the amplifier circuit portion of amplifier assembly 140 to right speaker 135 of speaker assembly 130. In some embodiments, speaker input cable 144 additionally includes one or more male jacks allowing one or more ends of speaker input cable 144 to be disconnected from an associated female jack, such as for user convenience.

Source cable 145 is a signal conduit that is configured to mechanically couple with the amplifier circuit portion of amplifier assembly 140 and includes source connector 146 that is a male jack configured to mechanically couple to an associated female audio source connector within mobile entertainment device 120. Source cable 145 is further configured to provide a conduit for an audio signal to travel from the mobile entertainment device 120 to the amplifier circuit portion of amplifier assembly 140. In some embodiments, source cable 145 additionally includes an additional male jack allowing the amplifier assembly end of source cable 145 to be disconnected from an associated female jack located at amplifier assembly 140, such as for user convenience.

Power assembly 150 is a power supply system including a transformer or switching circuit located within a housing, such as a wall adapter housing, that is configured to receive an AC power signal, from a power source, and produce a DC power signal based on the received AC power signal. Power assembly 150 includes power cable 151 having power connector 153 mechanically coupled to power cable 151, and alternating current (AC) wall adapter 152. AC-DC power supply systems are well know within the art and will not be discussed further.

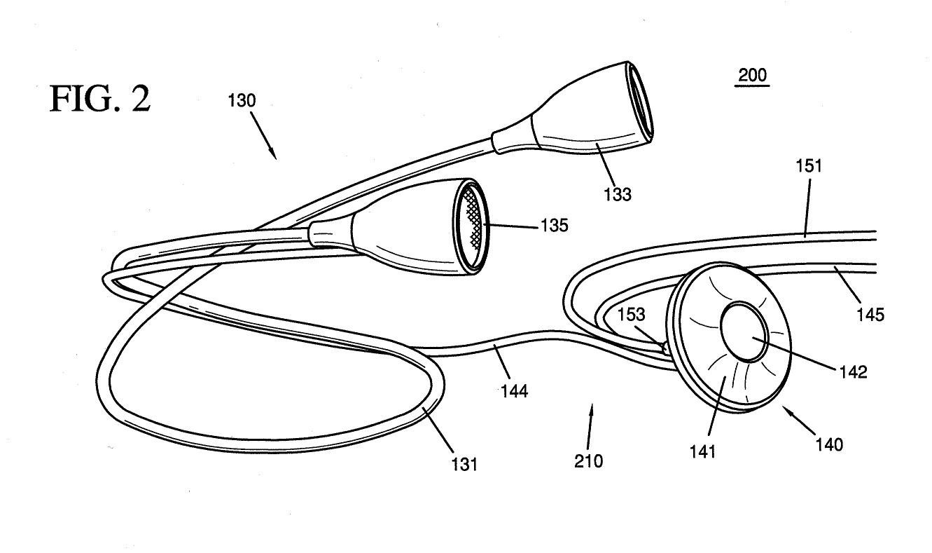

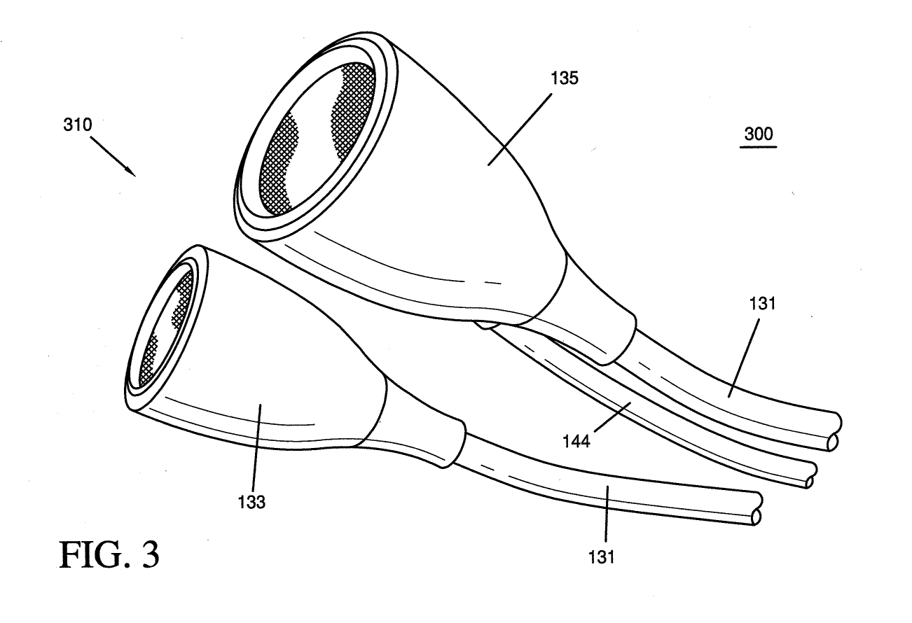

FIG. 2 illustrates a mobile audio entertainment system 200 for providing user controlled audio entertainment from a portable device accessory that is coupled to a mobile media device (not shown). Operational system 200 includes portable device accessory 210 that includes speaker assembly 130 and amplifier assembly 140 portions of portable device accessory 110 of mobile audio entertainment system 100 of FIG. 1, above. Elements numbered as in FIG. 1 function in a substantially similarly way. In FIG. 2, operational system 200 depicts how a user may position left speaker 133 and right speaker 135 by adjusting flexible member 131.

FIG. 3 illustrates a speaker system 300 for providing acoustic output from a portable device accessory that is coupled to a mobile media device (not shown). Speaker system 300 includes speaker assembly 310 that includes portions of speaker assembly 130 of portable device accessory 110 of mobile audio entertainment system 100 of FIG. 1, above. Elements numbered as in FIG. 1 function in a substantially similarly way. In FIG. 3, speaker system 300 depicts an example of manufactured left speaker 133 and right speaker 135 as well as associated elements and includes over-molding of said elements. In some embodiments, left speaker 133 and right speaker 135 are enclosed within an associated tuned (e.g., vented) acoustical cavity. In other embodiments, left speaker 133 and right speaker 135 include are enclosed within an associated sealed acoustical cavity.

In some embodiments, the associated sealed acoustical cavities are called speaker enclosures and can be manufactured from any suitable materials, such as, for example acrylonitrile butadiene styrene (ABS) plastic, as available from General Electric Corp of Fairfield, Conn. USA, but could be manufactured from other rigid or semi-rigid thermoplastic materials such as polycarbonate plastic or polystyrene plastic. In other embodiments, speaker enclosure portions can be manufactured from other materials such as wood or metal. In still other embodiments, speaker enclosure portions may be mechanically coupled to the flexible member using an over-mold methodology.

FIG. 4 illustrates a speaker system 400 for providing acoustic output from a portable device accessory that is coupled to a mobile media device (not shown). Speaker system 400 includes speaker assembly 410 that includes portions of speaker assembly 130 of portable device accessory 110 of mobile audio entertainment system 100 of FIG. 1, above. In FIG. 4, multiple views of portions of speaker system 400 are illustrated. Speaker assembly 410 additionally includes acoustical port (speaker vent) 431, cable/cord cavity 432 and speaker protective screen 434. Elements numbered as in FIG. 1 function in a substantially similarly way.

Acoustical port 431 is an acoustical vent (also referred to as a Hemholtz resonator) that provides tuning of an associated speaker cavity to provide an acoustically tuned response when combined with a tuned acoustical cavity, such as described in FIG. 3 above. Cable/cord cavity 432 provides a sealed point of entry into the acoustical cavity of speaker 135 for speaker input cable 144. Speaker protective screen 434, also referred to as a speaker grille, provides protection of the loud speaker cone portion of an associated speaker. In some embodiments, speakers 133 and 135 can be implemented as any suitable compact, portable speaker, such as, for example the JL 1169 speaker available from Smart Glory Electronics (ShenZhen) Co., Ltd. Located at Building Four, Huaguan Industrial Zone, Zhangqi Road, Qiping Village, Guanlan Town, ShenZhen City, China (P.R.C). In other embodiments, speakers 133 and 135 can be implemented as one or more 2 Watt (W), 4 Ohm (Ω) speakers, for example, part number FG-25SB04-3 available from Fortune Grand Enterprise Co., LTD of Taoyuan City, Taiwan. R.O.C.

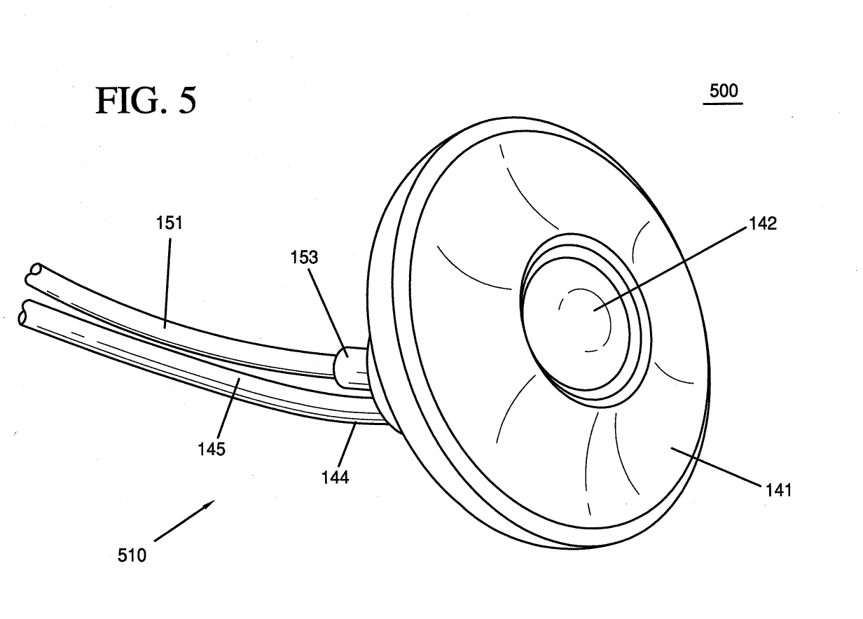

FIG. 5 illustrates an amplifier system 500 for receiving an audio signal from a mobile media device (not shown), producing an amplified audio signal powerful enough to drive one or more speakers based on the received audio signal, and providing the amplified audio signal to a speaker assembly (not shown). Amplifier system 500 includes amplifier assembly 510 that includes portions of amplifier assembly 140 of portable device accessory 110 of mobile audio entertainment system 100 of FIG. 1, above. Elements numbered as in FIG. 1 function in a substantially similarly way. In FIG. 5, amplifier system 500 depicts how a user may position amplifier assembly 510 and associated elements.

Although amplifier system 500 is depicted as including an amplifier circuit within amplifier assembly 510 requiring a DC power signal input, amplifier system 500 may be implemented using different power sources. Examples of such power sources include an amplifier circuit incorporating a power supply system including a transformer or switching circuit located within amplifier assembly 510, an amplifier circuit incorporating a power supply system powered by one or more batteries, and the like. Specific examples of amplifier assemblies incorporating exemplary power supply system are found in FIGS. 9-29, below.

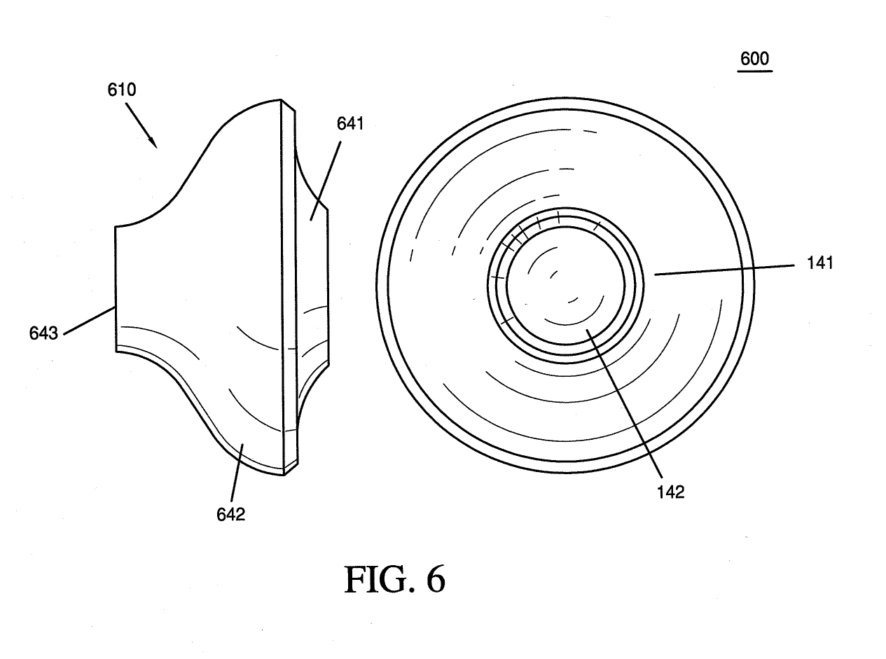

FIG. 6 illustrates an amplifier system 600 for receiving an audio signal from a mobile media device (not shown), producing an amplified audio signal powerful enough to drive one or more speakers based on the received audio signal, and providing the amplified audio signal to a speaker assembly (not shown). Amplifier system 600 includes amplifier assembly 610 that includes portions of amplifier assembly 140 of portable device accessory 110 of mobile audio entertainment system 100 of FIG. 1, above. In FIG. 6, multiple views of portions of amplifier system 600 are illustrated. Amplifier assembly 610 additionally includes a front housing portion 641, a rear housing portion 642 and cable/cord cavity 643. Elements numbered as in FIG. 1 function in a substantially similarly way.

In FIG. 6, front housing portion 641 is configured to mechanically couple to rear housing portion 642 and enclose the amplification circuit (described in FIG. 8, below). Front housing portion 641 is also configured to include amplifier switch 142 allowing a user to turn amplifier system 600, as well as mobile audio entertainment system 100, “on” and “off.” Cable/cord cavity 643 provides a sealed point of entry into the rear housing portion 642 of amplifier assembly 610 for speaker input cable 144, source cable 145 and power cable 151. In some embodiments, front housing portion 641 and rear housing portion 642 are manufactured as separate elements and thermally coupled after installation of the amplification circuit.

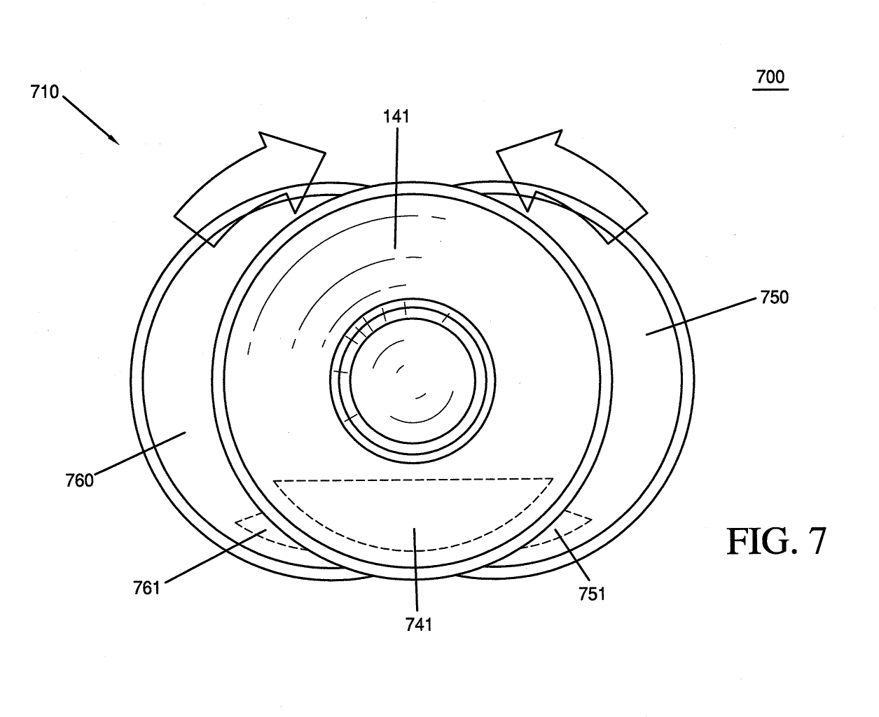

FIG. 7 illustrates an amplifier system 700 for receiving an audio signal from a mobile media device (not shown), producing an amplified audio signal powerful enough to drive one or more speakers based on the received audio signal, and providing the amplified audio signal to a speaker assembly (not shown). Amplifier system 700 includes amplifier assembly 710 that includes portions of amplifier assembly 140 of portable device accessory 110 of mobile audio entertainment system 100 of FIG. 1, above. In FIG. 7, different views of the same amplifier housing, of amplifier system 700, in multiple positions are provided. The multiple views provided illustrate amplifier housing 141 in different positions as the amplifier housing maneuvers to return to a first position, the set position. Amplifier assembly 710 additionally includes a steadying weight 741; a second amplifier housing position 750 includes a second steadying weight 751; and a third amplifier housing position 760 includes a third steadying weight 761. Elements numbered as in FIG. 1 function in a substantially similarly way.

In operation, steadying weight 741 forces amplifier housing 141 to rotate and rock back-and-forth passing through various positions until amplifier housing 141 obtains the desired position as defined by steadying weight 741 being located substantially near the surface upon which amplifier housing 141 is located. In an example, amplifier housing 141 can rotate/rock into a position as illustrated by second amplifier housing 750 and then rotate/tock into a position as illustrated by third amplifier housing 760 until amplifier housing 141 finally comes to rest with steadying weight 741 being located substantially near the surface upon which amplifier housing 141 is located.

FIG. 8 is a block diagram illustrating an embodiment of an amplifier system 800 of an exemplary system for providing user controlled audio entertainment from a portable device accessory that is coupled to a mobile media device. The amplifier system 800 in FIG. 8 is a detailed view of a portion of amplifier assembly 140 of FIG. 1. As shown in FIG. 8, amplifier system 800 includes amplifier circuit 810, mobile entertainment device 120 and speaker assembly 130. Speaker assembly 130 includes speakers 133 and 135. Amplifier circuit 810 is an audio amplifier circuit that includes: audio amplifier chip 820, optional sound field processing chip 825, light emitting diode (LED) 830, “on/off” switch 842, female power jack 843 and source connector 845. Elements numbered as in FIG. 1 function in a substantially similarly way.

In operation, amplifier circuit 810 receives a power signal via female power jack 843, and receives an audio signal from source 120 via source connector 845. LED 830 provides feedback to a user indicating amplifier system 800 is receiving power. In one embodiment, amplifier circuit 810 uses audio amplifier chip 820 in combination with optional sound field processing chip 825 to produce an amplified audio signal. In this embodiment, optional sound field processing chip 825 conditions the received audio signal to produce a spatial realistic sound effect from a stereo signal. Audio amplifier chip 820 receives the conditioned audio signal from optional sound field processing chip 825 and produces an amplified audio signal based on the received conditioned audio signal. In other embodiments (not shown), amplifier circuit 810 uses audio amplifier chip 820 to produce an amplified audio signal. In either of the embodiments, audio amplifier chip 820 passes an amplified audio signal to speaker assembly 130. Optional sound field processing chip 825 can be implemented as any suitable field processing chip, such as, the LA2616V surround signal processing chip available from Sanyo Semiconductor Co., Ltd. of Gunma, Japan. Audio amplifier chip 820 can be implemented as any suitable audio amplifier chip, such as, the LA4910T audio amplifier chip available from Sanyo Semiconductor Co., Ltd. of Gunma, Japan.

In FIG. 8, audio amplifier chip 820 includes an input and an output. In some embodiments and illustrated in FIG. 8, the input of amplifier chip 820 is electrically coupled to the output of optional sound field processing chip 825, and the output of amplifier chip 820 is coupled to speakers 133 and 135 of speaker assembly 130. In this embodiment, the input of audio amplifier chip 820 includes an AUD_RET pin, a LEFT_OUT pin and a RIGHT_OUT pin, and the output of audio amplifier chip 820 includes an L+ pin, L− pin, R+ pin and R− pin. Further to this embodiment, optional sound field processing chip 825 includes an input and an output. The input of optional sound field processing chip 825 includes an AUD_RET pin, a LEFT_IN pin and a RIGHT_IN pin, and the output of optional sound field processing chip 825 includes an AUD_RET pin, a LEFT_OUT pin and a RIGHT_OUT pin.

In FIG. 8, AUD_RET pin, LEFT_OUT pin and RIGHT_OUT pin of the output of optional sound field processing chip 825 are electrically coupled to an associated AUD_RET pin, LEFT_OUT pin and RIGHT OUT pin located at the input of audio amplifier chip 820. Further, L+ pin and L− pin of audio amplifier chip 820 are coupled to speaker 133 of speaker assembly 130, and R+ pin and R− pin of audio amplifier chip 820 are coupled to speaker 135 of speaker assembly 130. Both amplifier chip 820 and optional sound field processing chip 825 additionally include a power (PWR) pin. Each PWR pin is in electrical communication with power jack 843 via LED 830 and switch 842. Switch 842 can be used by a user to turn amplifier circuit 810 “on/off.” Power jack 843 is in electrical communication with a power source (not shown), such as, for example a wall power outlet.

In FIG. 8, source connector 845 includes an input and an output. The input of source connector 845 is operable to connect to mobile entertainment device 120, such as, for example via a 3.5 mm male audio connector, a universal serial bus (USB) connector, and the like. In some embodiments, the output of source connector 845 includes AUD_RET pin, LEFT_IN pin and RIGHT_IN pin that are configured to electronically couple to an associated AUD_RET pin, LEFT_IN pin and RIGHT_IN pin located at the input of optional sound field processing chip 825. In other embodiments and when optional sound field processing chip 825 is NOT a part of amplifier circuit 810, AUD_RET pin, LEFT_IN pin and RIGHT_IN of source connector 845 configured to electronically couple to an associated AUD_RET pin, LEFT_OUT pin and RIGHT_OUT pin located at the input of audio amplifier chip 820.

FIG. 9 illustrates a mobile audio entertainment system 900 for providing user controlled audio entertainment from a portable device accessory that is coupled to a mobile media device (not shown). FIG. 9 illustrates another embodiment of exemplary system 100 of FIG. 1 for providing user controlled audio entertainment from a portable device accessory. Mobile audio entertainment system 900 includes portable device accessory 910 that includes speaker assembly 130 and amplifier assembly 940. Elements numbered as in FIG. 1 function in a substantially similarly way. In FIG. 9, amplifier assembly 940 is implemented as a battery powered amplifier.

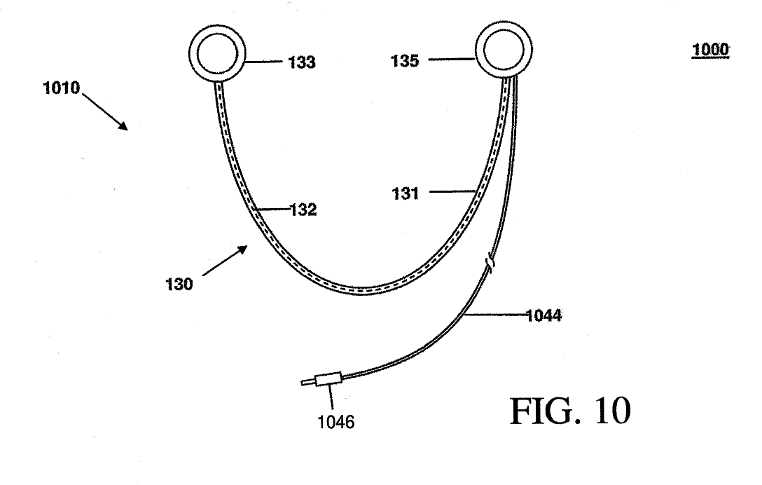

FIG. 10 illustrates a mobile audio entertainment system 1000 for providing user controlled audio entertainment from a portable device accessory that is coupled to a mobile media device (not shown). FIG. 10 illustrates yet another embodiment of exemplary system 100 of FIG. 1 for providing user controlled audio entertainment from a portable device accessory. Mobile audio entertainment system 1000 includes portable device accessory 1010 that includes speaker assembly 130 and speaker input cable 1044 that further includes source connector 1046 that is a male jack configured to mechanically couple to an associated female audio source connector within the mobile media device (not shown). Elements numbered as in FIG. 1 function in a substantially similarly way. In FIG. 10, mobile audio entertainment system 1000 does not include an external amplifier circuit relying instead on the mobile media device (not shown) to provide an amplified audio signal to speaker assembly 130 via speaker input cable 1044.

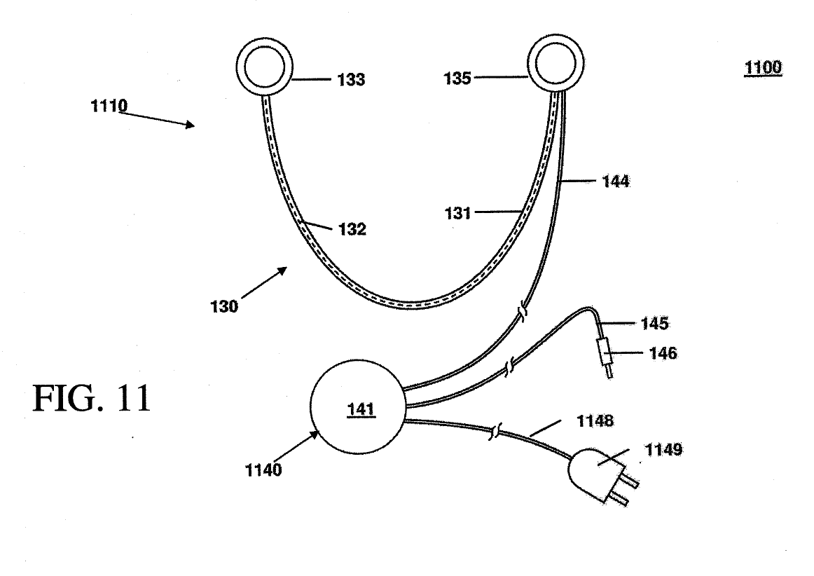

FIG. 11 illustrates a mobile audio entertainment system 1100 for providing user controlled audio entertainment from a portable device accessory that is coupled to a mobile media device (not shown). FIG. 11 illustrates still another embodiment of exemplary system 100 of FIG. 1 for providing user controlled audio entertainment from a portable device accessory. Mobile audio entertainment system 1100 includes portable device accessory 1110 that includes speaker assembly 130 and amplifier assembly 1140. Elements numbered as in FIG. 1 function in a substantially similarly way. In FIG. 11, amplifier assembly 1140 is implemented as an AC-DC power source amplifier and includes an AC power cord 1148 and an AC receptacle plug 1149.

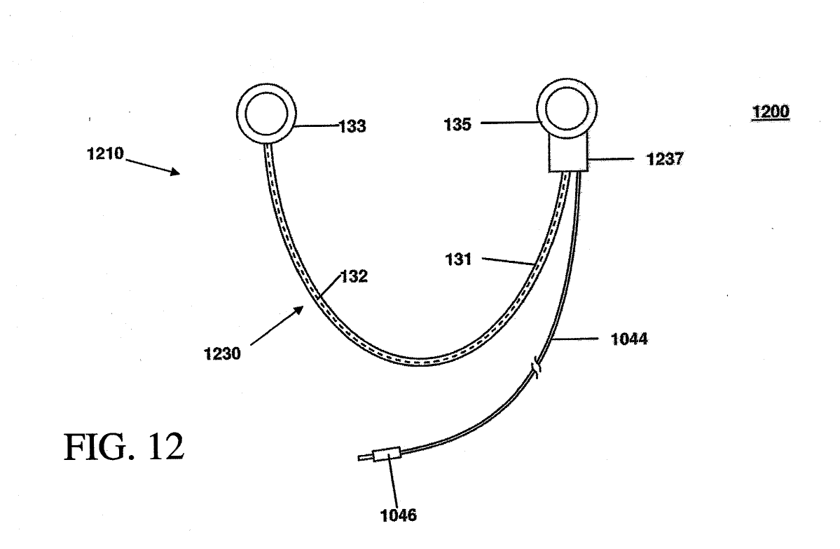

FIG. 12 illustrates a mobile audio entertainment system 1200 for providing user controlled audio entertainment from a portable device accessory that is coupled to a mobile media device (not shown). FIG. 12 illustrates yet still another embodiment of exemplary system 100 of FIG. 1 for providing user controlled audio entertainment from a portable device accessory. Mobile audio entertainment system 1200 includes portable device accessory 1210 that includes speaker assembly 1230 that includes amplifier assembly 1237 and speaker input cable 1044 that further includes source connector 1046 that is a male jack configured to mechanically couple to an associated female audio source connector within the mobile media device (not shown). Elements numbered as in FIGS. 1 and 10 function in a substantially similarly way. In FIG. 12, amplifier assembly 1237 is co-located with speaker 135 of speaker assembly 1230 and is implemented as a battery powered amplifier.

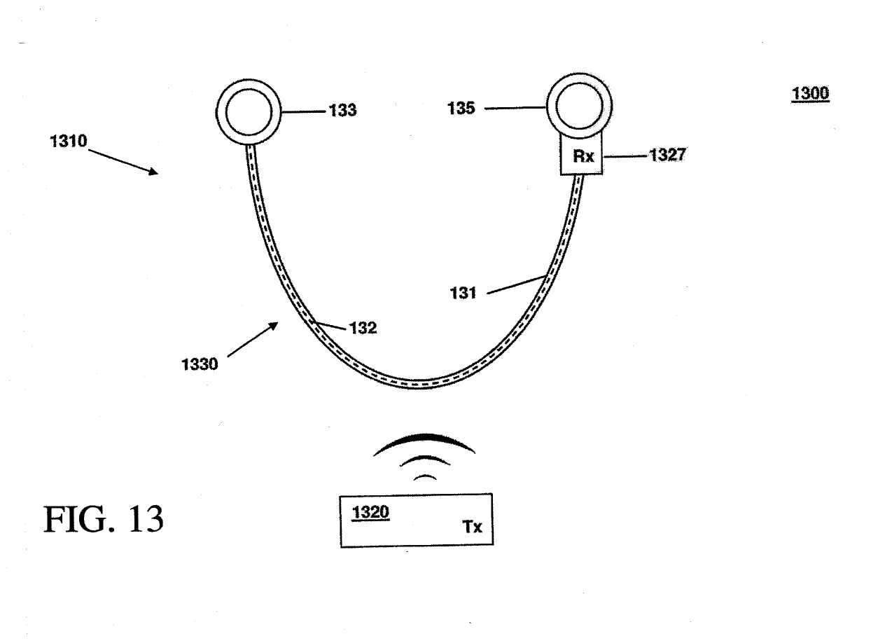

FIG. 13 illustrates a mobile audio entertainment system 1300 for providing user controlled audio entertainment from a portable device accessory that is wirelessly coupled to a mobile media device. FIG. 13 illustrates another embodiment of exemplary system 100 of FIG. 1 for providing user controlled audio entertainment from a portable device accessory. Elements numbered as in FIG. 1 function in a substantially similarly way. Mobile audio entertainment system 1300 includes portable device accessory 1310 and mobile entertainment device 1320 that is in wireless communication with portable device accessory 1310. Portable device accessory 1310 includes speaker assembly 1330 that further includes wireless amplifier assembly 1337. In FIG. 13, wireless amplifier assembly 1337 is co-located with speaker 135 of speaker assembly 1330 and is implemented as a battery powered amplifier that includes a wireless receiver.

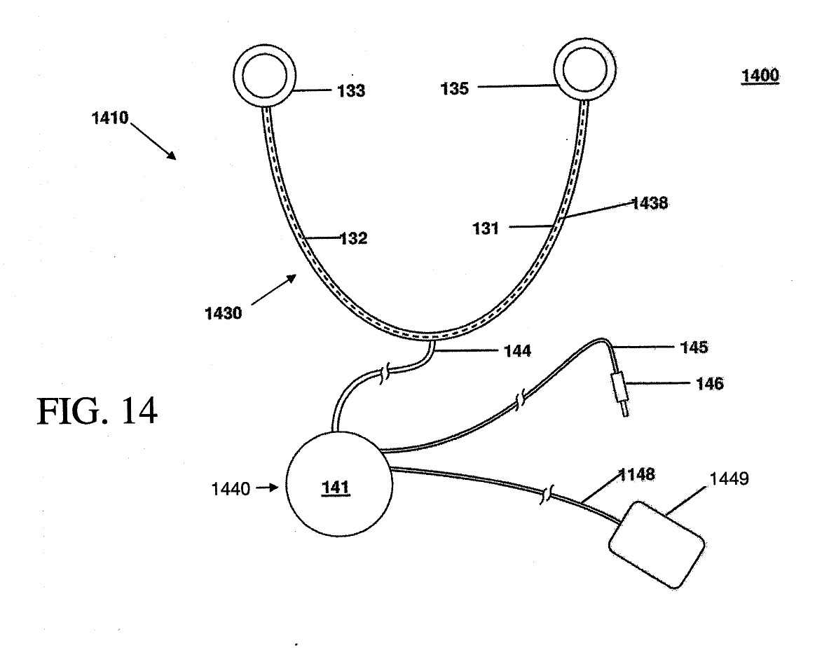

FIG. 14 illustrates a mobile audio entertainment system 1400 for providing user controlled audio entertainment from a portable device accessory that is coupled to a mobile media device (not shown). FIG. 14 illustrates still another embodiment of exemplary system 100 of FIG. 1 for providing user controlled audio entertainment from a portable device accessory. Mobile audio entertainment system 1400 includes portable device accessory 1410 that includes speaker assembly 1430 and amplifier assembly 1140. Elements numbered as in FIGS. 1 and 11 function in a substantially similarly way. Speaker assembly 1430 includes a second speaker cable 1438 that is also electrically coupled to speaker input cable 144 of amplifier assembly 1140. In FIG. 14, amplifier assembly 1140 is implemented as an AC-DC power source amplifier and includes AC power cord 1148 and a wall wart 1449. Wall wart 1449 can be a receptacle plug in which the electrical prongs can be hidden in the plug by folding the prongs. In addition, wall wart 1449 can include an AC-DC converter, a surge protector, a voltage/current regulator, and/or a line conditioner. As an example, wall wart 1449 can regulate and condition the power passing from the AC power source into amplifier assembly 1140. In some embodiments, wall wart 1449 can be similar to AC wall adaptor 152 (FIG. 1), or vice versa.

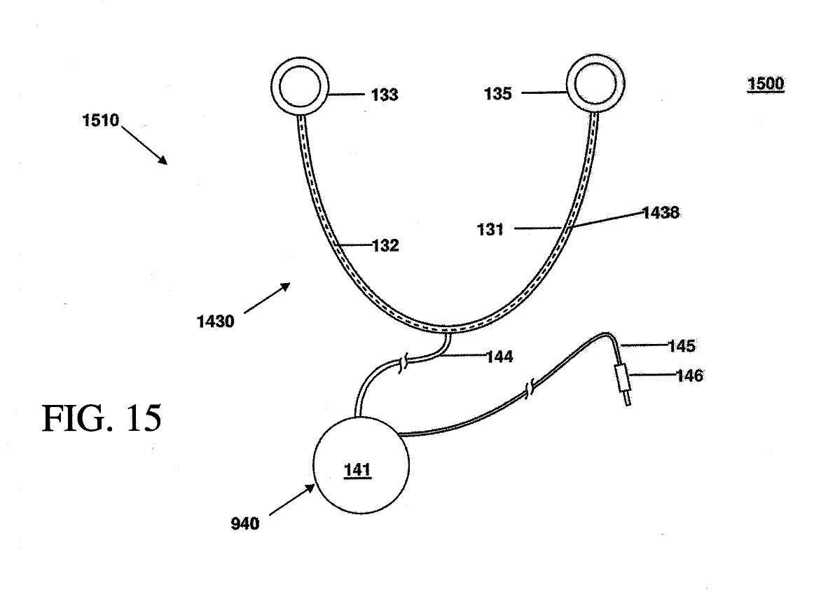

FIG. 15 illustrates a mobile audio entertainment system 1500 for providing user controlled audio entertainment from a portable device accessory that is coupled to a mobile media device (not shown). FIG. 15 illustrates yet another embodiment of exemplary system 100 of FIG. 1 for providing user controlled audio entertainment from a portable device accessory. Mobile audio entertainment system 1500 includes portable device accessory 1510 that includes speaker assembly 1430 and amplifier assembly 940. Elements numbered as in FIGS. 1, 9 and 14 function in a substantially similarly way. In FIG. 15, amplifier assembly 940 is implemented as a battery powered amplifier.

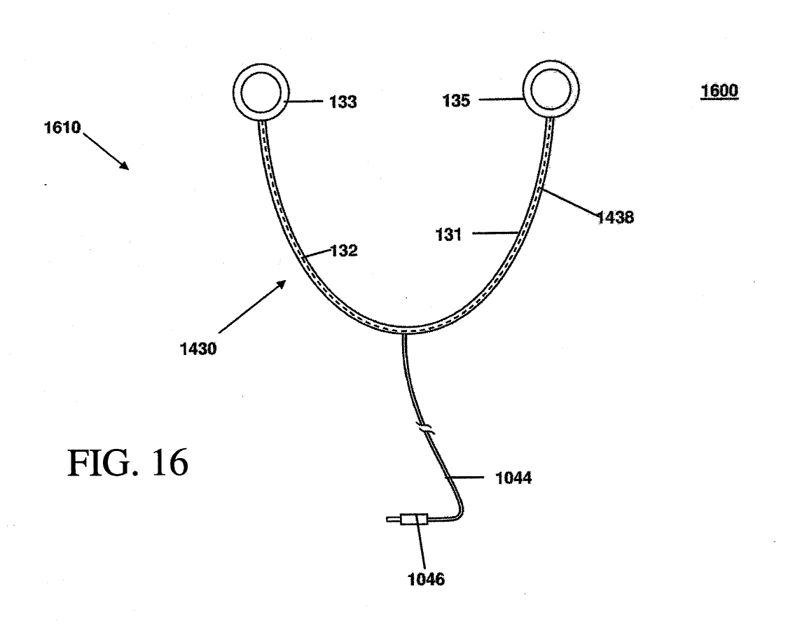

FIG. 16 illustrates a mobile audio entertainment system 1600 for providing user controlled audio entertainment from a portable device accessory that is coupled to a mobile media device (not shown). FIG. 16 illustrates yet still another embodiment of exemplary system 100 of FIG. 1 for providing user controlled audio entertainment from a portable device accessory. Mobile audio entertainment system 1600 includes portable device accessory 1610 that includes speaker assembly 1430 and speaker input cable 1044 that further includes source connector 1046 that is a male jack configured to mechanically couple to an associated female audio source connector within the mobile media device (not shown). Elements numbered as in FIGS. 1, 10 and 14 function in a substantially similarly way. In FIG. 16, mobile audio entertainment system 1600 does not include an external amplifier circuit relying instead on the mobile media device (not shown) to provide an amplified audio signal to speaker assembly 1430 via speaker input cable 1044.

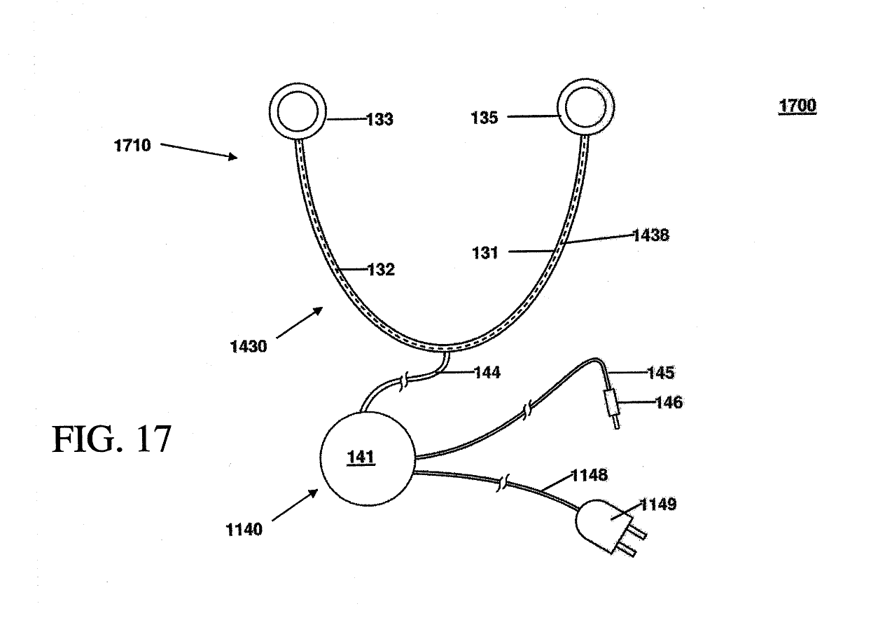

FIG. 17 illustrates a mobile audio entertainment system 1700 for providing user controlled audio entertainment from a portable device accessory that is coupled to a mobile media device (not shown). FIG. 17 illustrates another embodiment of exemplary system 100 of FIG. 1 for providing user controlled audio entertainment from a portable device accessory. Mobile audio entertainment system 1700 includes portable device accessory 1710 that includes speaker assembly 1430 and amplifier assembly 1140. Elements numbered as in FIGS. 1, 11 and 14 function in a substantially similarly way. In FIG. 17, amplifier assembly 1140 is implemented as an AC-DC power source amplifier.

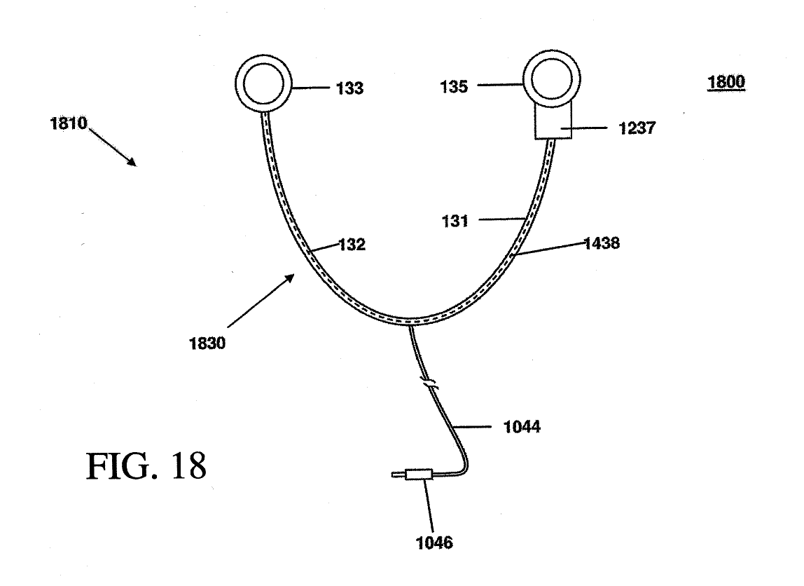

FIG. 18 illustrates a mobile audio entertainment system 1800 for providing user controlled audio entertainment from a portable device accessory that is coupled to a mobile media device (not shown). FIG. 18 illustrates yet another embodiment of exemplary system 100 of FIG. 1 for providing user controlled audio entertainment from a portable device accessory. Elements numbered as in FIGS. 1, 10, 12 and 14 function in a substantially similarly way. Mobile audio entertainment system 1800 includes portable device accessory 1810 that includes speaker assembly 1830 that further includes amplifier assembly 1237, and speaker input cable 1044 that further includes source connector 1046 that is a male jack configured to mechanically couple to an associated female audio source connector within the mobile media device (not shown). Speaker assembly 1830 also includes a second speaker cable 1438 that is also electrically coupled to speaker input cable 1044. In FIG. 18, amplifier assembly 1237 is co-located with speaker 135 of speaker assembly 1830 and is implemented as a battery powered amplifier.

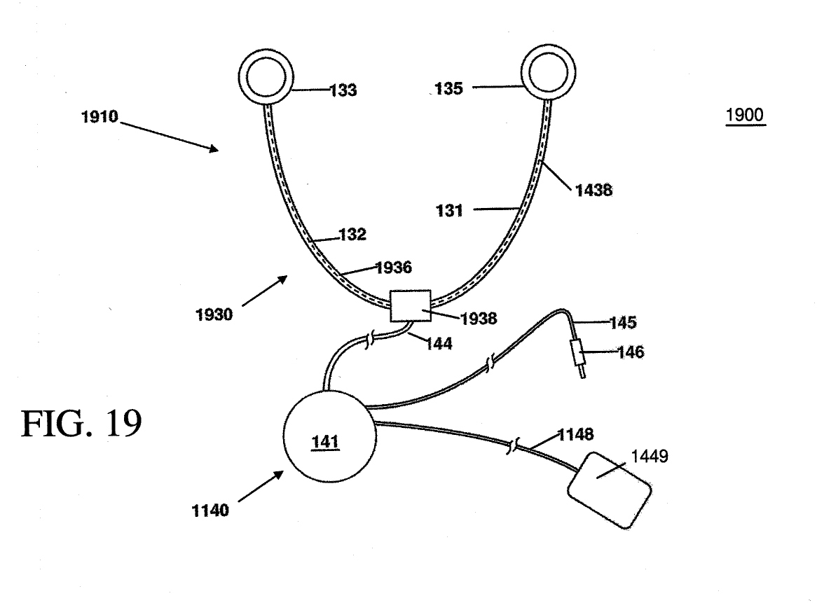

FIG. 19 illustrates a mobile audio entertainment system 1900 for providing user controlled audio entertainment from a portable device accessory that is coupled to a mobile media device (not shown). FIG. 19 illustrates still another embodiment of exemplary system 100 of FIG. 1 for providing user controlled audio entertainment from a portable device accessory. Mobile audio entertainment system 1900 includes portable device accessory 1910 that includes speaker assembly 1930 and amplifier assembly 1140. Elements numbered as in FIGS. 1, 11 and 14 function in a substantially similarly way. Speaker assembly 1930 includes flexible member connector 1938 that is mechanically coupled to flexible member 131 as well as to a second flexible member 1936. Second flexible member 1936 is mechanically coupled speaker 133 and flexible member 131 is additionally coupled to speaker 135. Flexible member connector 1938 is coupled to speaker input cable 144 of amplifier assembly 1140 and provides speaker input cable 144 access to speaker cable 132 and second speaker cable 1438. In FIG. 19, amplifier assembly 1140 is implemented as an AC-DC power source amplifier and includes AC power cord 1148 and wall wart 1449.

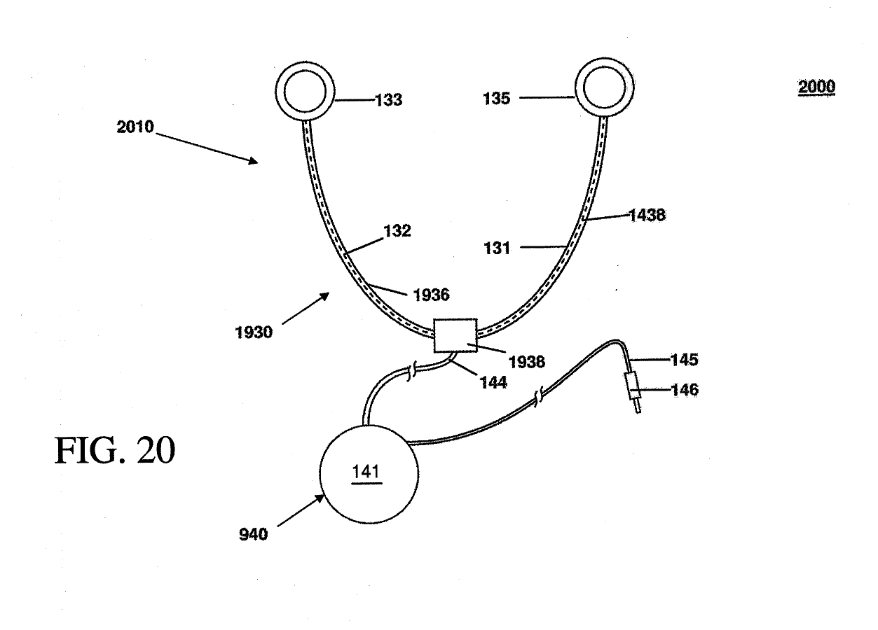

FIG. 20 illustrates a mobile audio entertainment system 2000 for providing user controlled audio entertainment from a portable device accessory that is coupled to a mobile media device (not shown). FIG. 20 illustrates yet still another embodiment of exemplary system 100 of FIG. 1 for providing user controlled audio entertainment from a portable device accessory. Mobile audio entertainment system 2000 includes portable device accessory 2010 that includes speaker assembly 1930 and amplifier assembly 940. Elements numbered as in FIGS. 1, 9, 14 and 19 function in a substantially similarly way. In FIG. 19, amplifier assembly 940 is implemented as a battery powered amplifier.

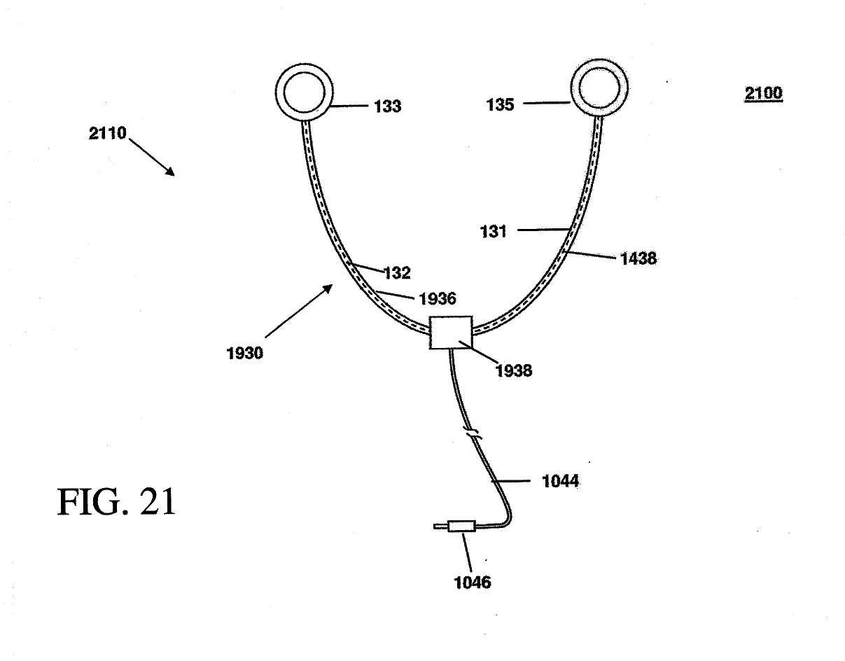

FIG. 21 illustrates a mobile audio entertainment system 2100 for providing user controlled audio entertainment from a portable device accessory that is coupled to a mobile media device (not shown). FIG. 21 illustrates another embodiment of exemplary system 100 of FIG. 1 for providing user controlled audio entertainment from a portable device accessory. Mobile audio entertainment system 2100 includes portable device accessory 2110 that includes speaker assembly 1930 and speaker input cable 1044 that further includes source connector 1046 that is a male jack configured to mechanically couple to an associated female audio source connector within the mobile media device (not shown). Elements numbered as in FIGS. 1, 10, 14 and 19 function in a substantially similarly way. In FIG. 21, mobile audio entertainment system 2100 does not include an external amplifier circuit relying instead on the mobile media device (not shown) to provide an amplified audio signal to speaker assembly 1930 via speaker input cable 1044.

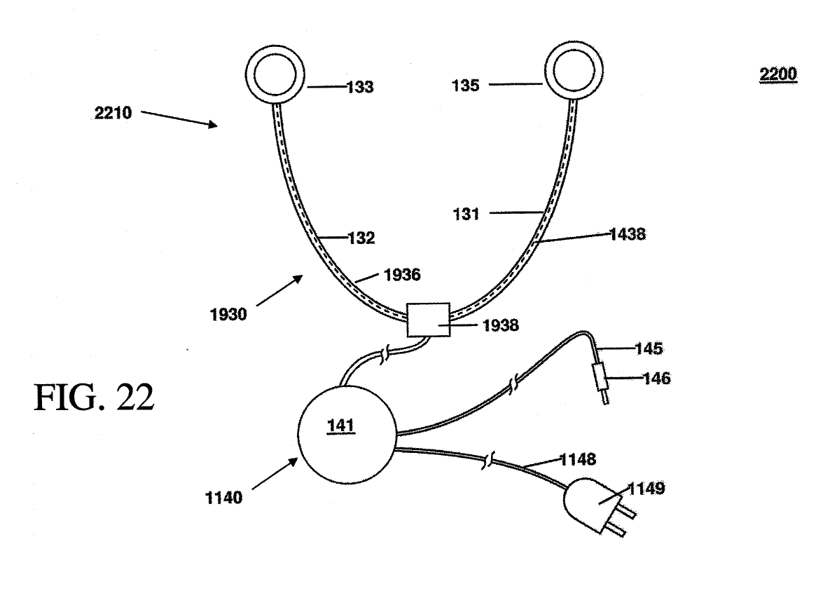

FIG. 22 illustrates a mobile audio entertainment system 2200 for providing user controlled audio entertainment from a portable device accessory that is coupled to a mobile media device (not shown). FIG. 22 illustrates yet another embodiment of exemplary system 100 of FIG. 1 for providing user controlled audio entertainment from a portable device accessory. Mobile audio entertainment system 2200 includes portable device accessory 2210 that includes speaker assembly 1930 and amplifier assembly 1140. Elements numbered as in FIGS. 1, 11, 14 and 19 function in a substantially similarly way. In FIG. 22, amplifier assembly 1140 is implemented as an AC-DC power source amplifier.

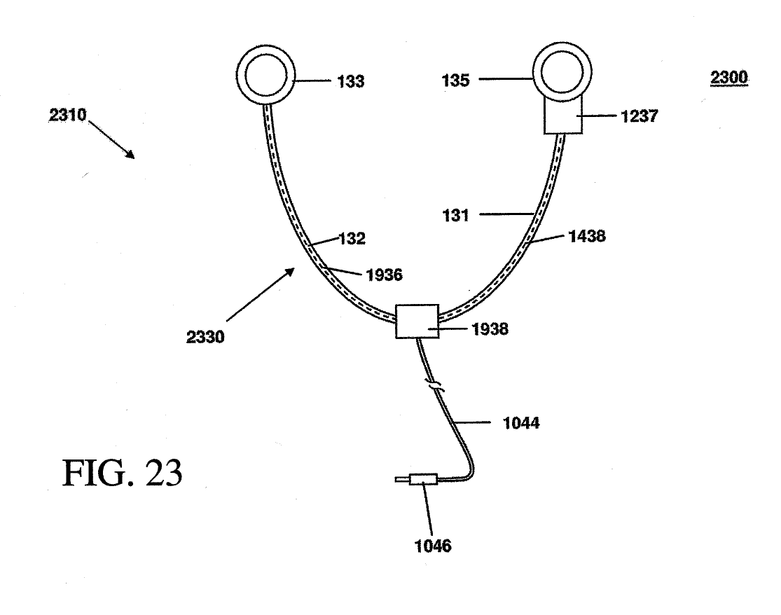

FIG. 23 illustrates a mobile audio entertainment system 2300 for providing user controlled audio entertainment from a portable device accessory that is coupled to a mobile media device (not shown). FIG. 23 illustrates still another embodiment of exemplary system 100 of FIG. 1 for providing user controlled audio entertainment from a portable device accessory. Elements numbered as in FIGS. 1, 10, 12, 14 and 19 function in a substantially similarly way. Mobile audio entertainment system 2300 includes portable device accessory 2310 that includes speaker assembly 2330 and speaker input cable 1044 that further includes source connector 1046 that is a male jack configured to mechanically couple to an associated female audio source connector within the mobile media device (not shown). Speaker assembly 2330 additionally includes amplifier assembly 1237 and flexible member connector 1938 that is mechanically coupled to flexible member 131 as well as to second flexible member 1936. Second flexible member 1936 is mechanically coupled to speaker 133 and flexible member 131 is additionally coupled to speaker 135. Flexible member connector 1938 is coupled to speaker input cable 1044 of amplifier assembly 1140. Speaker assembly 2330 additionally includes a second speaker cable 1438 that is also electrically coupled to speaker input cable 1044. Flexible member connector 1938 provides speaker input cable 144 access to speaker cable 132 and second speaker cable 1438. In FIG. 23, amplifier assembly 1237 is co-located with speaker 135 of speaker assembly 2330 and is implemented as a battery powered amplifier.

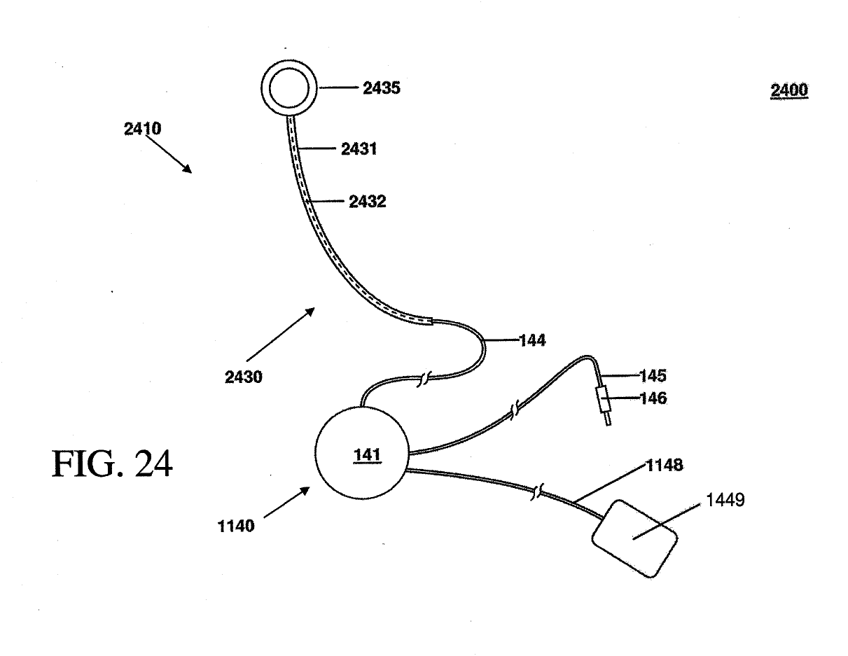

FIG. 24 illustrates a mobile audio entertainment system 1900 for providing user controlled audio entertainment from a portable device accessory that is coupled to a mobile media device (not shown). FIG. 24 illustrates yet still another embodiment of exemplary system 100 of FIG. 1 for providing user controlled audio entertainment from a portable device accessory. Mobile audio entertainment system 2400 includes portable device accessory 2410 that includes speaker assembly 2430 and amplifier assembly 1140. Elements numbered as in FIGS. 1 and 11 function in a substantially similarly way. Speaker assembly 2430 includes flexible member 2431 that is mechanically coupled speaker 2435. In some embodiments, flexible member 2431 is implemented as a flexible hose with a hollow core and further includes speaker cable 2432 located within the hollow core and electrically coupled to speaker 2435. Flexible member 2431 is coupled to speaker input cable 144 of amplifier assembly 1140 and provides speaker input cable 144 access to speaker cable 2432. In FIG. 24, amplifier assembly 1140 is implemented as an AC-DC power source amplifier and includes AC power cord 1148 and wall wart 1449.

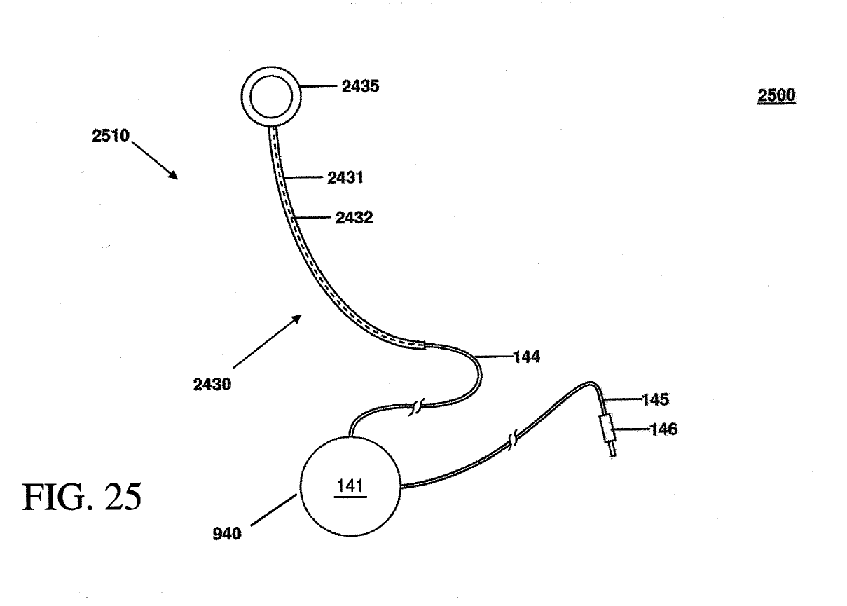

FIG. 25 illustrates a mobile audio entertainment system 2500 for providing user controlled audio entertainment from a portable device accessory that is coupled to a mobile media device (not shown). FIG. 25 illustrates another embodiment of exemplary system 100 of FIG. 1 for providing user controlled audio entertainment from a portable device accessory. Mobile audio entertainment system 2500 includes portable device accessory 2510 that includes speaker assembly 2430 and amplifier assembly 940. Elements numbered as in FIGS. 1, 9, and 24 function in a substantially similarly way. In FIG. 25, amplifier assembly 940 is implemented as a battery powered amplifier.

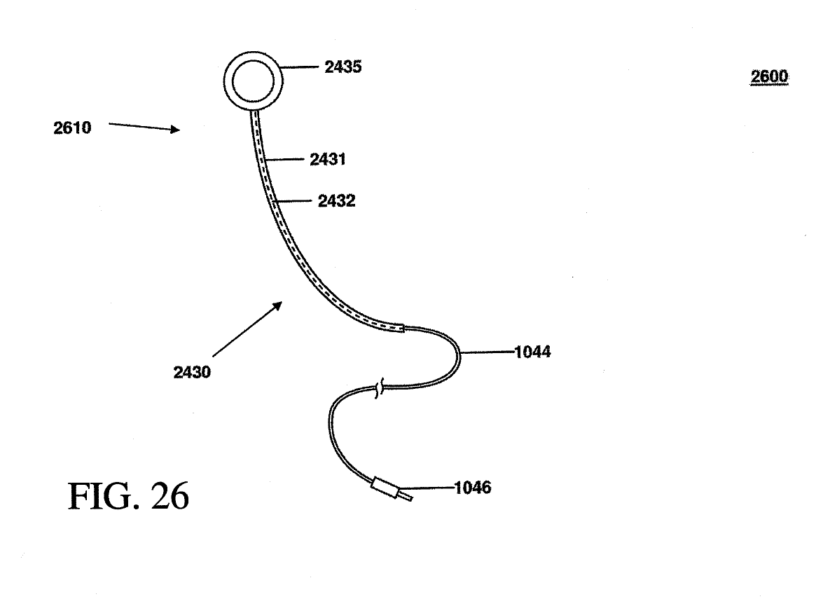

FIG. 26 illustrates a mobile audio entertainment system 2600 for providing user controlled audio entertainment from a portable device accessory that is coupled to a mobile media device (not shown). FIG. 26 illustrates yet another embodiment of exemplary system 100 of FIG. 1 for providing user controlled audio entertainment from a portable device accessory. Mobile audio entertainment system 2600 includes portable device accessory 2610 that includes speaker assembly 2430 and speaker input cable 1044 that further includes source connector 1046 that is a male jack configured to mechanically couple to an associated female audio source connector within the mobile media device (not shown). Elements numbered as in FIGS. 10 and 24 function in a substantially similarly way. In FIG. 26, mobile audio entertainment system 2600 does not include an external amplifier circuit relying instead on the mobile media device (not shown) to provide an amplified audio signal to speaker assembly 2430 via speaker input cable 1044.

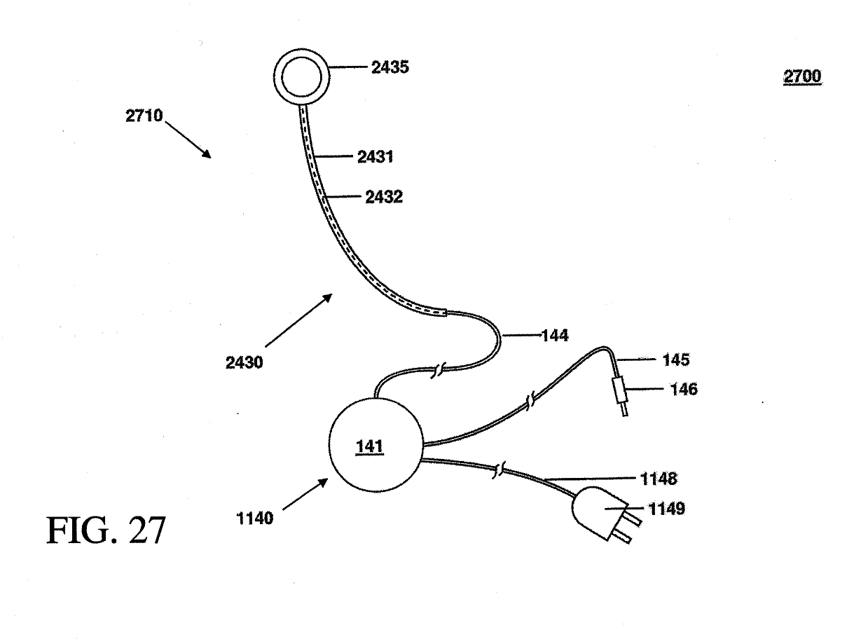

FIG. 27 illustrates a mobile audio entertainment system 2700 for providing user controlled audio entertainment from a portable device accessory that is coupled to a mobile media device (not shown). FIG. 27 illustrates still another embodiment of exemplary system 100 of FIG. 1 for providing user controlled audio entertainment from a portable device accessory. Mobile audio entertainment system 2700 includes portable device accessory 2710 that includes speaker assembly 2430 and amplifier assembly 1140. Elements numbered as in FIGS. 1, 11 and 24 function in a substantially similarly way. In FIG. 27, amplifier assembly 1140 is implemented as an AC-DC power source amplifier.

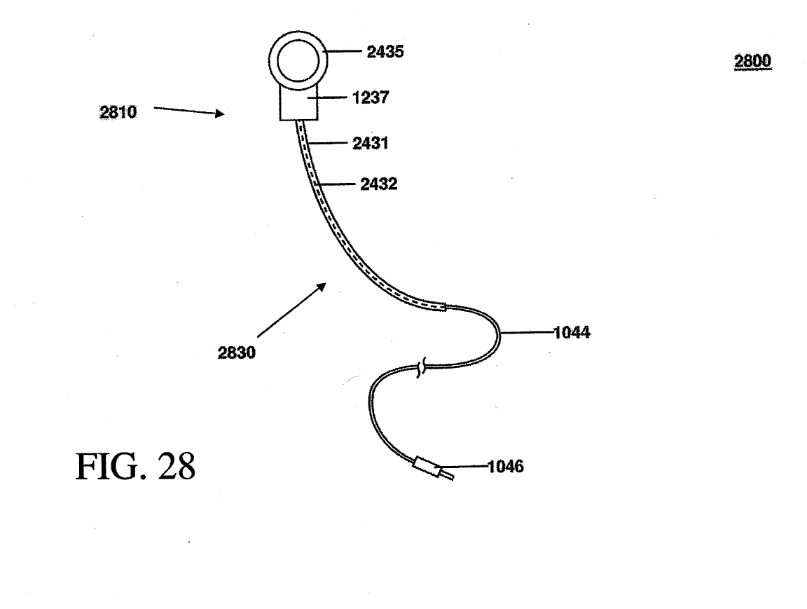

FIG. 28 illustrates a mobile audio entertainment system 2800 for providing user controlled audio entertainment from a portable device accessory that is coupled to a mobile media device (not shown). FIG. 28 illustrates yet still another embodiment of exemplary system 100 of FIG. 1 for providing user controlled audio entertainment from a portable device accessory. Elements numbered as in FIGS. 10, 12 and 24 function in a substantially similarly way. Mobile audio entertainment system 2800 includes portable device accessory 2810 that includes speaker assembly 2830 that additionally includes amplifier assembly 1237, and speaker input cable 1044 that further includes source connector 1046 that is a male jack configured to mechanically couple to an associated female audio source connector within the mobile media device (not shown). In FIG. 24, amplifier assembly 1237 is co-located with speaker 2435 of speaker assembly 2830 and is implemented as a battery powered amplifier.

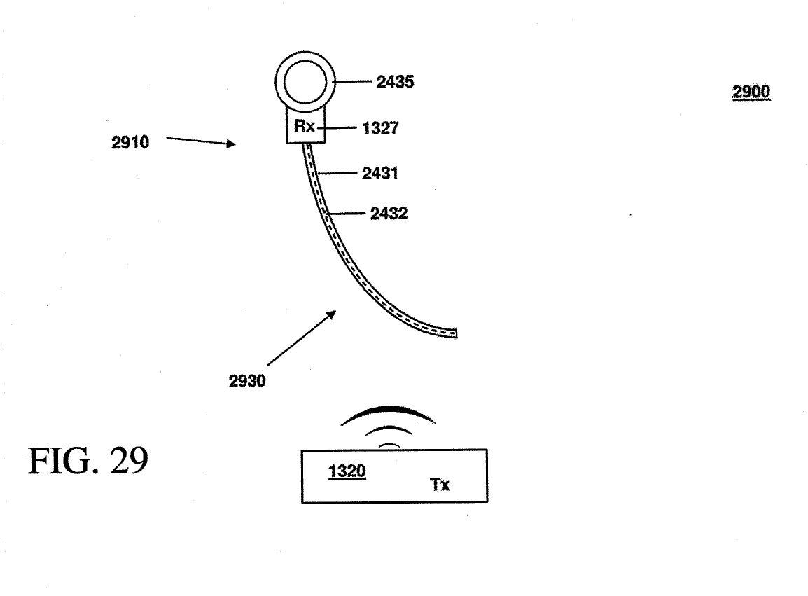

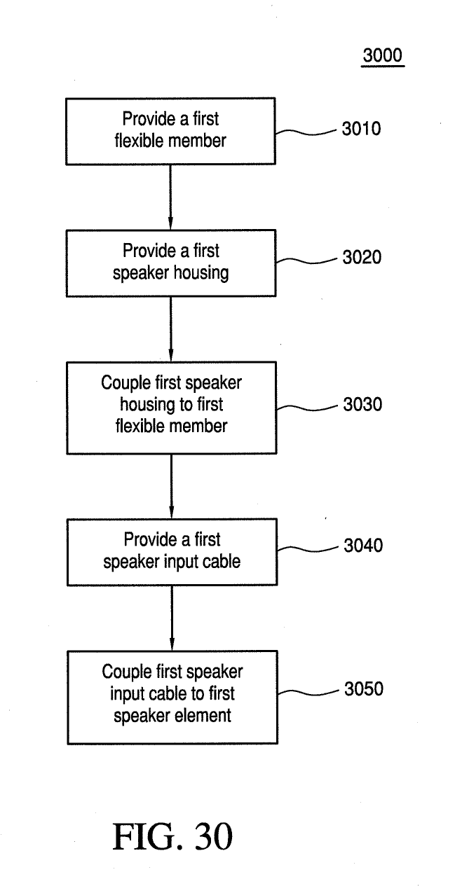

FIG. 29 illustrates a mobile audio entertainment system 2900 for providing user controlled audio entertainment from a portable device accessory that is wirelessly coupled to a mobile media device. FIG. 29 illustrates another embodiment of exemplary system 100 of FIG. 1 for providing user controlled audio entertainment from a portable device accessory. Elements numbered as in FIGS. 13 and 24 function in a substantially similarly way. Mobile audio entertainment system 2900 includes portable device accessory 2910 and mobile entertainment device 1320 that is in wireless communication with portable device accessory 2910. Portable device accessory 2910 includes speaker assembly 2930 that further includes wireless amplifier assembly 1337. In FIG. 29, wireless amplifier assembly 1327 is co-located with speaker 2435 of speaker assembly 2930 and is implemented as a battery powered amplifier that includes a wireless receiver.

FIG. 30 illustrates an example of a method 3000 of manufacturing a portable device according to embodiments of the invention. Method 3000 of FIG. 30 includes a process 3010 of providing a first flexible member. The first flexible member can comprise a first flexible member cavity that runs form a first end of the first flexible member to a second end of the first flexible member. The first flexible member can be the same as or similar to flexible member 131 (FIGS. 1-4, and 9-23) and flexible member 2431 (FIGS. 24-29).

Next, method 3000 of FIG. 30 includes a process 3020 of providing a first speaker housing. The first speaker housing can comprise a first speaker element. The first speaker housing in combination with the first speaker element can be the same as or similar to speaker 133 (FIGS. 1-4, 9-23), speaker 135 (FIGS. 1-4, 9-23), or speaker 2435 (FIGS. 24-29). It should be noted that the order of processes 3010 and 3020 can be reversed, or process 3010 and process 3020 can be performed at the same time.

Method 3000 continues with a process 3030 of coupling the first speaker housing to the first end of the first flexible member. As an example, FIGS. 1-4 and 9-23 show flexible member 131 coupled to speaker 135, and FIGS. 24-29 show flexible member 2431 coupled to speaker 2135.

Subsequently, method 3000 of FIG. 30 continues with a process 3040 of providing a first speaker input cable. As an example, the first speaker input cable can be the same as or similar to speaker input cable 144 (FIGS. 1-5, 9, 11, 14, 15, 17, 19, 20, 22, 24, 25, 27) or speaker input cable 1044 (FIGS. 10, 12, 16, 18, 21, 23, 26, 28).

Next, method 3000 proceeds with a process 3050 of coupling the first speaker input cable to the first speaker element. As an example FIGS. 1-4, and 9-28 show speaker input cable 144 or 1044 coupled to speaker 135 or speaker 2135. It should be noted that the order of processes 3030, 3040, and 3050 can be altered. For example, process 3040 can be performed before process 3030. In addition, processes 3040 and 3050 can be performed before process 3030.

Although aspects of the subject matter described herein have been described with reference to specific embodiments, it will be understood by those skilled in the art that various changes may be made without departing from the scope of the subject matter described herein. Accordingly, the disclosure of embodiments is intended to be illustrative of the scope of the subject matter described herein and is not intended to be limiting. It is intended that the scope of the subject matter described herein shall be limited only to the extent required by the appended claims. To one of ordinary skill in the art, it will be readily apparent that the devices and method discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the subject matter described herein and claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A portable speaker assembly, comprising:
a first flexible member, the first flexible member having a first end and a second end, the first flexible member including a first flexible member cavity running from the first end of the first flexible member to the second end of the first flexible member;
a first speaker housing coupled to the first end of the first flexible member, the first speaker housing including a first speaker element; and
a first speaker input cable having a first end and a second end, the first end of the first speaker input cable coupled to the first speaker element of the first speaker housing, the first speaker input cable of sufficient length to allow the first speaker input cable to couple with a mobile entertainment device.

2. The portable speaker assembly of claim 1, wherein the first speaker input cable travels the length of the cavity of the first flexible member.

3. The portable speaker assembly of claim 2, wherein the mobile entertainment device provides power to operate the first speaker element and the power to operate the first speaker element is received to the first speaker element through the first speaker input cable.

4. The portable speaker assembly of claim 2, further comprising:
an amplifier assembly including an amplifier circuit, the amplifier circuit having an input, an output and a power source, the output of the amplifier circuit coupled to the second end of the first speaker input cable; and
a source cable, the source cable having a first end and a second end, the first end of the source cable coupled to the input of the amplifier circuit, the second end of the source cable configured to couple with the mobile entertainment device.

5. The portable speaker assembly of claim 4, wherein the amplifier assembly is located away from the first flexible member.

6. The portable speaker assembly of claim 5, wherein the power source of the amplifier circuit is selected from the group consisting of: a battery powered power circuit, an AC-DC power source located at the amplifier assembly, or an AC-DC power source located away from the amplifier assembly and providing DC power to the amplifier assembly.

7. The portable speaker assembly of claim 4, wherein the amplifier assembly is coupled to the first flexible member and the first speaker element, and the first flexible member passes through a portion of the amplifier assembly.

8. The portable speaker assembly of claim 7, wherein the power source of the amplifier circuit is a battery powered power circuit.

9. The portable speaker assembly of claim 1, further comprising:
a second speaker housing coupled to the second end of the first flexible member, the second speaker housing including a second speaker element; and
a second speaker input cable, the second speaker input cable of sufficient length to travel the length of the cavity of the first flexible member, the second speaker input cable having a first end and a second end, the first end of the second speaker input cable coupled to the first speaker element of the first speaker housing and the second end of the second input speaker cable coupled to the second speaker element of the second speaker housing.

10. The portable speaker assembly of claim 9, wherein the mobile entertainment device provides power to operate the first speaker element and the second speaker element and the power to operate the first speaker element and the second speaker element is received to the portable speaker assembly through the first speaker input cable.

11. The portable speaker assembly of claim 9, further comprising:
an amplifier assembly including an amplifier circuit, the amplifier circuit having an input, an output and a power source, the output of the amplifier circuit coupled to the second end of the first speaker input cable; and
a source cable, the source cable having a first end and a second end, the first end of the source cable coupled to the input of the amplifier circuit, the second end of the source cable configured to couple with the mobile entertainment device.

12. The portable speaker assembly of claim 11, wherein the amplifier assembly is located away from the first flexible member.

13. The portable speaker assembly of claim 12, wherein the power source of the amplifier circuit is selected from the group consisting of: a battery powered power circuit, an AC-DC power source located at the amplifier assembly, or an AC-DC power source located away from the amplifier assembly and providing DC power to the amplifier assembly.

14. The portable speaker assembly of claim 11, wherein the amplifier assembly is coupled to the first flexible member and the first speaker, and the first flexible member passes through a portion of the amplifier assembly.

15. The portable speaker assembly of claim 14, wherein the power source of the amplifier circuit is a battery powered power circuit.

16. The portable speaker assembly of claim 1, further comprising
a flexible member connector coupled to the second end of the first flexible member, the flexible member connector including a flexible member connector cavity having a first opening, a second opening and a third opening, the first opening of the flexible member connector cavity in communication with the first flexible member cavity of the first flexible member;
a second flexible member, the second flexible member having a first end and a second end, the second flexible member including a second flexible member cavity running from the first end of the second flexible member to the second end of the second flexible member, the second end of the second flexible member coupled to the flexible member connector, the second flexible member cavity in communication with the second opening of the flexible member connector cavity;
a second speaker housing coupled to the first end of the second flexible member, the second speaker housing including a second speaker element; and
a second speaker input cable, the second speaker input cable of sufficient length to travel a length of the first flexible member cavity, the flexible member connector cavity and the second flexible member cavity, the second speaker input cable having a first end and a second end, the first end of the second speaker input cable coupled to the first speaker element of the first speaker housing and the second end of the second input speaker cable coupled to the second speaker element of the second speaker housing.

17. The portable speaker assembly of claim 16, wherein the mobile entertainment device provides power to operate the first speaker element and the second speaker element and the power to operate the first speaker element and the second speaker element is received to the portable speaker assembly through the first speaker input cable.

18. The portable speaker assembly of claim 16, further comprising:
an amplifier assembly including an amplifier circuit, the amplifier circuit having an input, an output and a power source, the output of the amplifier circuit coupled to the second end of the first speaker input cable; and
a source cable, the source cable having a first end and a second end, the first end of the source cable coupled to the input of the amplifier circuit, the second end of the source cable configured to couple with the mobile entertainment device.

19. The portable speaker assembly of claim 16, wherein the amplifier assembly is located away from the first flexible member and the second flexible member.

20. The portable speaker assembly of claim 19, wherein the power source of the amplifier circuit is selected from the group consisting of: a battery powered power circuit, an AC-DC power source located at the amplifier assembly, or an AC-DC power source located away from the amplifier assembly and providing DC power to the amplifier assembly.

21. The portable speaker assembly of claim 16, wherein the amplifier assembly is coupled to the first flexible member and the first speaker, and the first flexible member passes through a portion of the amplifier assembly.

22. The portable speaker assembly of claim 21, wherein the power source of the amplifier circuit is a battery powered power circuit.

23. A wireless portable speaker assembly, comprising:
a flexible member, the flexible member having a first end and a second end;
a first speaker housing coupled to the first end of the flexible member, the first speaker housing including a first speaker element; and
a wireless amplifier assembly including a wireless amplifier circuit, the wireless amplifier circuit coupled to the flexible member and the first speaker element, and the flexible member passes through a portion of the wireless amplifier assembly, the wireless amplifier assembly having an input, an output and a power source, the output of the wireless amplifier circuit coupled to the first speaker element of the first speaker housing, the input of the wireless amplifier circuit in wireless communication with a wireless mobile entertainment device.

24. The wireless portable speaker assembly of claim 23, wherein the power source of the wireless amplifier circuit is a battery powered power circuit.

25. The wireless portable speaker assembly of claim 23, further comprising:
cavity within the flexible member, the cavity running from the first end of the flexible member to the second end of the flexible member;
a second speaker housing coupled to the second end of the flexible member, the second speaker housing including a second speaker element; and
a first speaker input cable, the first speaker input cable of sufficient length to travel the length of the cavity of the flexible member, the first speaker input cable having a first end and a second end, the first end of the first speaker input cable coupled to the first speaker element of the first speaker housing and the second end of the first input speaker cable coupled to the second speaker element of the second speaker housing; and
wherein the wireless amplifier assembly is in electrical communication with the second speaker element via the first speaker input cable.

26. The wireless portable speaker assembly of claim 25, wherein the power source of the wireless amplifier circuit is a battery powered power circuit.

27. A system for providing audio entertainment, comprising:
a source means for providing an audio source signal; and
a speaker means in communication with the source means, the speaker means for receiving the audio source signal, producing an acoustic signal and propagating the acoustic signal to a surrounding geographic area.

28. The system of claim 27, further comprising amplification means in communication with the source means and the speaker means, the amplification means for receiving the audio source signal from the source means, producing an amplified audio source signal based on the received audio signal, and passing the amplified audio source signal to the speaker means, and wherein the audio source signal is the amplified audio source signal.

29. A method of manufacturing a portable speaker assembly, comprising:
providing a first flexible member comprising a first flexible member cavity that runs from a first end of the first flexible member to a second end of the first flexible member;
providing a first speaker housing, wherein the first speaker housing comprises a first speaker element;
coupling the first speaker housing to the first end of the first flexible member;
providing a first speaker input cable having a sufficient length to allow the first speaker input cable to couple with a mobile entertainment device; and
coupling a first end of the first speaker input cable to the first speaker element.

30. The method of claim 29, further comprising:
providing an amplifier assembly comprising an amplifier circuit;
coupling an output of the amplifier circuit to a second end of the first speaker input cable;
providing a source cable having a first end and having a second end configured to be coupled with the mobile entertainment device; and
coupling the first end of the source cable to an input of the amplifier circuit.

31. The method of claim 29, further comprising:
providing a second speaker housing comprising a second speaker element;
coupling the second speaker housing to the second end of the first flexible member;
providing a second speaker input cable having a sufficient length to travel the length of the first flexible member cavity;
coupling a first end of the second speaker input cable to the first speaker element; and
coupling a second end of the second input speaker cable to the second speaker element.

32. The method of claim 31, further comprising:
providing an amplifier assembly comprising an amplifier circuit;
coupling an output of the amplifier circuit to a second end of the first speaker input cable;
providing a source cable having a first end and having a second end configured to be coupled with the mobile entertainment device; and
coupling the first end of the source cable to an input of the amplifier circuit.

33. The method of claim 29, further comprising:
providing a flexible member connector comprising a flexible member connector cavity having a first opening, a second opening, and a third opening;
coupling the flexible member connector to the second end of the first flexible member, wherein the first opening of the flexible member connector cavity is in communication with the first flexible member cavity;
providing a second flexible member, wherein the second flexible member comprises a second flexible member cavity that extends from a first end of the second flexible member to a second end of the second flexible member;
coupling the second end of the second flexible member to the flexible member connector, wherein the second opening of the flexible member connecter cavity is in communication with the second flexible member cavity;
providing a second speaker housing comprising a second speaker element;
coupling the second speaker housing to the first end of the second flexible member;
providing a second speaker input cable having sufficient length to travel a combined length of the first flexible member cavity, the second flexible member cavity, and the flexible member connector cavity;
coupling a first end of the second speaker input cable to the first speaker element; and
coupling a second end of the second speaker input cable to the second speaker element.

34. The method of claim 33, further comprising:
providing an amplifier assembly comprising an amplifier circuit;
coupling an output of the amplifier circuit to a second end of the first speaker input cable;
providing a source cable having a first end and having a second end configured to be coupled with the mobile entertainment device; and
coupling the first end of the source cable to an input of the amplifier circuit.
